(19) United States
(12) Patent Application Publication
(10) Pub. No.: US 2026/0313503 A1
(43) Pub. Date: Oct. 8, 2026

(54) HANDOVER MANAGEMENT METHOD AND APPARATUS BETWEEN TN AND NTN

(71) Applicant: ULAK HABERLESME ANONIM SIRKETI, Ankara (TR)

(72) Inventors: Evren TUNA, Ankara (TR); Huseyin ARSLAN, Istanbul (TR)

(73) Assignee: ULAK HABERLESME ANONIM SIRKETI, Ankara (TR)

(21) Appl. No.: 19/482,238

(22) PCT Filed: Dec. 5, 2023
(86) PCT No.: PCT/TR2023/051464

§ 371 Date: Nov. 7, 2025

(30) Foreign Application Priority Data
May 12, 2023 (TR) 2023/005315

(51) Int. Cl. H04W 36/30; H04W 84/06

(52) U.S. Cl. CPC H04W 36/304; H04W 84/06

(57) ABSTRACT

The provided is a handover management method realized by a handover management unit for controlling handover of user equipment between a terrestrial network and non-terrestrial network. The method includes steps of monitoring QCI based metrics for each service connected to a first network type or a second network type wherein first network type are different than each other and selected from a group consisting of terrestrial network and non-terrestrial network, acquiring UE information and UE based metrics from user equipment belonging to monitored services; determining at least a candidate network for each service which is in different network type the network type currently being used by said services for handover; generating predicted UE based metric and predicted QCI based metric for a future time window using a machine learning algorithm for first network type and second network type using UE information as input.

### CROSS-REFERENCE TO THE RELATED APPLICATIONS

This application is the national phase entry of International Application No. PCT/TR2023/051464, filed on Dec. 5, 2023, which is based upon and claims priority to Turkish Patent Application No. 2023/005315, filed on May 12, 2023, the entire contents of which are incorporated herein by reference.

### TECHNICAL FIELD

The present invention is related to a handover management method realized by a handover management unit for controlling handover of user equipment between a terrestrial network and non-terrestrial network.

### BACKGROUND

In current communication networks, there are two types of networks-terrestrial (TN) and non-terrestrial (NTN). Terrestrial networks use physical infrastructure on the Earth's surface, such as copper or fiber-optic cables, radio waves, or microwaves, to transmit data between devices. Non-terrestrial networks, on the other hand, operate beyond the Earth's surface, such as in space or in the air, and are often used for global communication or for specialized applications.

In a communication system, handover refers to the process of transferring an active call or data session from one network cell or base station to another. Handover between TN and NTN can be challenging due to the difference in coverage area, signal strength, and latency. Handover process can cause service disruption, delay, and loss of data.

To address these challenges, an efficient multi-connectivity and handoff mechanism should be realized in the coverage area where TN and NTN can serve a user equipment (UE). The handover decision depends on the application requirement and the availability of network resources. If the UE uses a delay-tolerant application, it is not feasible to hand off UE to NTN. However, if the UE uses an application that requires a high data rate, it would be better to hand off UE to NTN. Moreover, NTN provides an advantage for massive machine type communication (mMTC). The UE can also change the utilized application. We can have scarce of resources.

Currently, there exist automation-based or some AI-based solutions to overcome this problem. However, these solutions do not consider computation and deployment criteria, do not consider the multivariate dataset usage, and do not provide detailed information about integrating with 3GPP RAN, 3GPP CN, and O-RAN. The limitations of these solutions can cause network congestion, service interruption, and user dissatisfaction. Therefore, it is necessary to provide a mechanism for multi-connectivity and handoff between TN and NTN that considers all these criteria and provides seamless and efficient communication services to end-users. All the problems mentioned above have made it necessary to make an innovation in the relevant technical field as a result.

### SUMMARY

The present invention relates to handover management apparatus and a method to eliminate the above-mentioned disadvantages and bring new advantages to the relevant technical field.

An object of the invention is to realize handover in a more precise manner between terrestrial network and non-terrestrial network.

Another object of the invention is to avoid unnecessary handovers between terrestrial network and non-terrestrial network.

An object of the invention is to realize multi-connectivity in a more precise manner between terrestrial network and non-terrestrial network.

Another object of the invention is to increase services' service level agreement meeting rate.

To achieve all the objects mentioned above and that will emerge from the following detailed description, the present invention relates to a handover management method realized by a handover management unit for controlling handover of user equipment between a terrestrial network and non-terrestrial network. Accordingly, it is characterized in that comprising steps of monitoring quality of service class identifier (QCI) based metrics for each service connected to a first network type or a second network type wherein first network type are different than each other and selected from a group consisting of terrestrial network and non-terrestrial network, acquiring UE information and UE based metrics from user equipment belonging to monitored services; determining at least a candidate network for each service which is in different network type the network type currently being used by said services for handover; generating predicted UE based metric and predicted QCI based metric for a future time window using a machine learning algorithm for first network type and second network type using UE information as input, where said machine learning algorithm is trained with reference user equipment information, reference UE based metric, reference QCI based metric taken on first network type and second network type; if generated predicted UE metric and predicted QCI based metric meet predetermined conditions handover at least a service of user equipment from existing network type to other network type. Thus, handover between TN and NTN is provided in a way that more suitable network connections are detected. Further, services meet SLA more frequently.

A possible embodiment of the invention is characterized in that said QCI based metrics are selected from a group consisting of: packet delay measurement; radio resource utilization measurement, radio resource control (RRC) connection number measurement and protocol data unit (PDU) session management metric.

Another possible embodiment of the invention is characterized in that said UE based metrics are selected from a group consisting of: UE based metrics may be evolved universal terrestrial radio access network (E-UTRAN)-radio access bearer (RAB) (E-RAB) Accessibility, E-RAB Retain ability, E-UTRAN internet protocol (IP) Throughput, E-UTRAN IP Latency, E-UTRAN Cell Availability, E-UTRAN Mobility, Packet Delay.

Another possible embodiment of the invention is characterized in that said UE information are selected from a group consisting of: UE type, UE location, UE speed, UE movement direction.

The present invention is also a handover management unit comprising a communication interface for acquiring metrics from user equipment, terrestrial network and non-terrestrial network; a processor which is configured to receive acquired metrics and control handover of user equipment; and a memory unit for storing data. Accordingly, it is characterized in that wherein said control unit is configured to perform following steps; monitoring QCI based metrics for each service connected to a first network type or a second network type wherein first network type are different than each other and selected from a group consisting of terrestrial network and non-terrestrial network, acquiring UE information and UE based metrics from user equipment belonging to monitored services; determining at least a candidate network for each service which is in different network type the network type currently being used by said services for handover; generating predicted UE based metric and predicted QCI based metric for a future time window using a machine learning algorithm for first network type and second network type using UE information as input, where said machine learning algorithm is trained with reference user equipment information, reference UE based metric, reference QCI based metric taken on first network type and second network type; if generated predicted UE metric and predicted QCI based metric meet predetermined conditions handover at least a service of user equipment from existing network type to other network type.

Another possible embodiment of the invention is characterized in that said handover management unit is provided in transmission points in the terrestrial network.

Another possible embodiment of the invention is characterized in that said handover management unit is provided on low earth orbit (LEO) satellite or aerial units in the non-terrestrial network. Thus, distributed computation is provided, reducing computational load of network controller or other type of single controllers.

### BRIEF DESCRIPTION OF THE DRAWINGS

FIG. 1 is a drawing illustrating top schematic view of the system.

FIG. 2 depicts schematic view of the Handover management unit.

### DETAILED DESCRIPTION OF THE EMBODIMENTS

In this detailed description, the subject matter is explained with references to examples without forming any restrictive effect only in order to make the subject more understandable.

Reference is made to Third Generation Partnership Project (3GPP) system, in accordance with embodiments of the present disclosure. The present application employs abbreviations, terms and technology defined in accord with Third Generation Partnership Project (3GPP) technology standards, including the following standards and definitions. 3GPP technical specifications (TS) and technical reports (TR) incorporated in their entirety by reference herein, define the related terms and architecture reference models that follow.
TN: Terrestrial Network
NTN: Non Terrestrial Network
LEO: Low Earth Orbit
GEO: Geostationary Orbit
QCI: Quality of Service Class Identifier
gNB: 5G Base Station
UPF: User Plane Function
NG-RAN nodes: Next Generation Radio Access Network nodes
E-RAB: E-UTRAN (Evolved Universal Terrestrial Radio Access Network) Radio Access Bearer
E-UTRAN IP: Evolved Universal Terrestrial Radio Access Network IP (Internet Protocol)
NR-Uu: 5G New Radio air interface
O-RAN: Open Radio Access Network
NG interface: Next Generation Interface
E2: Interface between the gNB and the NG-RAN controller
O1: Interface between the O-RAN Radio Unit (O-RU) and O-RAN Distributed Unit (O-DU)
UAVs: Unmanned Aerial Vehicles
ASPs: Aerial Sensor Platforms
ASTs: Airborne Support Terminals
Xn interface: Interface between two gNBs in the 5G core network
Xn-C interface: Interface between a gNB and an NG-RAN controller
RRC: Radio Resource Control
PDU: Protocol Data Unit
DL: Downlink
UL: Uplink
PRB: Physical Resource Block
SLA: Service Level Agreement
gNb: 5G base station
UPF: User Plane Function
NG-RAN nodes

Present invention is a handover management unit (100) which is deployed on a non-terrestrial network and/or on a non-terrestrial network in a plural manner for managing handover of user equipment (300) between TN and NTN; and a method thereof.

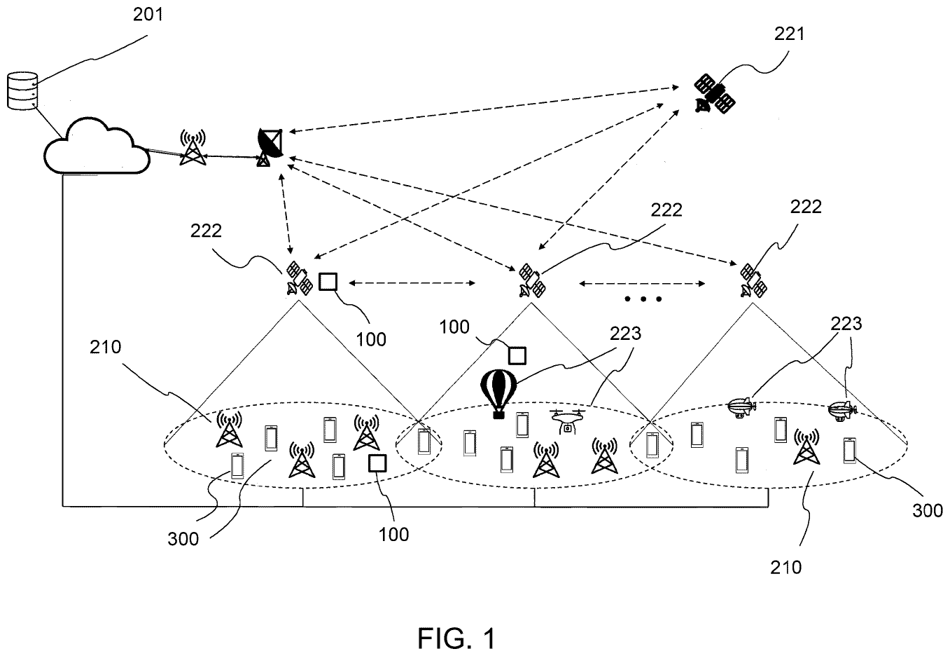

Referring to FIG. 1, non-terrestrial network, comprises transmission points (210) for providing service to user equipment (300), and a network controller (201) is provided for controlling transmission points (210). Terrestrial network is a type of communication network that operates on the Earth's surface or within its atmosphere, Transmission points (210) are located on the ground and may comprise equipment such as cell towers, base stations, or access points that transmit signals over the air to user equipment (300).

User equipment (300) can include devices such as smartphones, laptops, or other wireless-enabled devices that can receive signals from the transmission points (210) and communicate with other devices on the network.

The network controller (201) is responsible for managing the flow of traffic between the transmission points (210) and user equipment (300), and for coordinating the allocation of network resources to ensure that all users receive the appropriate level of service quality.

Plurality of non-terrestrial network may be provided.

Referring to FIG. 1, terrestrial network comprises GEO satellites (221) in geostationary orbit (GEO), LEO satellites (222) in low Earth orbit (LEO), and other aerial units (223) such as unmanned aerial vehicles (UAVs), aerial sensor platforms (ASPs), or airborne support terminals (ASTs).

GEO satellites (221) are positioned in a fixed location above the Earth's equator and provide continuous coverage over a specific geographic region. GEO satellites (221) may be used for applications such as satellite TV or radio, as well as for long-distance communication in remote or rural areas.

LEO satellites (222), on the other hand, are positioned at lower altitudes than GEO satellites and travel in circular or elliptical orbits around the Earth. LEO satellites (222) may provide coverage over a much wider area than GEO satellites (221), but require a constellation of multiple satellites to provide continuous coverage.

Other aerial units (223), such as UAVs, ASPs, or ASTs, are often used for military or surveillance applications, and can provide real-time data and communication capabilities in remote or inaccessible locations.

The network controller (201) is also connected to non-terrestrial network for managing the flow of traffic between the various transmission points (210) and user equipment (300), and for coordinating the allocation of network resources to ensure that all users receive the appropriate level of service quality.

Handover management unit (100) may be provided on transmission points (210) of terrestrial network and/or on LEO satellites (222) and/or aerial units (223) of non-terrestrial network. In a possible embodiment, handover management unit (100) is provided on transmission points (210). Said transmission points (210) may belong to different communication cells. In another possible embodiment handover management unit (100) may be provided on aerial units (223) or LEO satellites (222). In another possible embodiment, handover management unit (100) may be provided on transmission points (210) and LEO satellites (222) and aerial units (223).

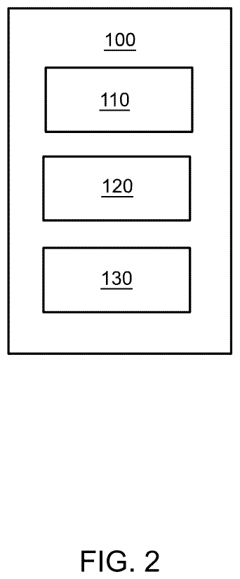

Referring to FIG. 2, plurality of user equipment (300) is provided. User equipment (300), are connected to either terrestrial network or non-terrestrial network. User equipment (300) use at least a service type. User equipment (300) may use multiple services at the same time. User equipment (300) may connect different network types at the same time (multi-connectivity).

Referring to FIG. 2, handover management unit (100) comprises a communication interface (110) in order to receive information, metric and commands relating to networks, user equipment (300). Communication interface (110) may comprise an Xn interface. The Xn interface is a standard interface defined in the 5G mobile network architecture. It is used to connect different NG-RAN nodes in network. The Xn interface enables communication between gNBs and UPFs in different locations, allowing for seamless handovers and efficient routing of user data across the network. This interface is responsible for the exchange of control plane messages, which are used to manage the network connection, as well as the exchange of user plane data, which contains the actual data being transmitted between the user equipment (300) and the network. In addition to facilitating communication between gNBs and UPFs, the Xn interface also enables other key 5G network features, such as network slicing and service continuity, which help to ensure that users receive a consistent level of service quality as they move between different parts of the network.

In more detail, Xn interface may support, procedures to support intra-NG-RAN mobility; procedures to support dual connectivity between NG-RAN nodes. Xn Interface may provide following functions: Xn-C interface management and error handling functions, UE mobility management functions; Dual connectivity function; Resource coordination function; Load management function.

Handover management unit (100) may comprise a processor unit (120) and a memory unit (130). Memory unit (130) comprises software that is run by processor unit (120) where said software may consist of functional modules. Processor unit (120) may comprise one or more microprocessors, digital signal processors, or other specialized processor units (120), as well as dedicated memory modules and input/output interfaces. The processor unit (120) may also include software modules for executing various algorithms and protocols, as well as firmware for controlling the operation of the hardware components.

Memory unit (130), may comprise volatile and non-volatile memory hardware that store data and software run by processor unit (120).

Processor unit (120) is configured to receive metrics related to network and user equipment (300). Network based metrics may be QCI based metrics. QCI based metrics may be following metrics: packet delay, radio resource utilization, RRC connection number and PDU session management metrics. Packet Delay (per PLMN ID and per QoS level (mapped QCI in NR option 3) and per supported S-NSSAI) may comprise following metrics: average delay DL air-interfac, Distribution of delay DL air-interface, Average delay UL on over-the-air interface, Distribution of DL delay between NG-RAN and UE, Distribution of UL delay between NG-RAN and UE. Radio resource utilization metrics may comprise following metrics: DL Total PRB Usage, UL Total PRB Usage, Distribution of DL Total PRB Usage, Distribution of UL total PRB usage, DL total available PRB, UL total available PRB. RRC connection number metric may be. Mean number of RRC Connections, Mean number of stored inactive RRC Connections. PDU session management metrics may be: Number of PDU Sessions requested to setup and Number of PDU Sessions successfully setup.

User equipment (300) related features may be UE based metrics and UE information. UE based metrics may be E-RAB Accessibility, E-RAB Retain ability, E-UTRAN IP Throughput, E-UTRAN IP Latency, E-UTRAN Cell Availability, E-UTRAN Mobility, Packet Delay (per PLMN ID and per QoS level (mapped QCI in NR option 3) and per supported S-NSSAI).

One of the user equipment (300) feature may be UE information. UE information may be, UE type, UE location, UE speed, UE movement direction etc.

Memory unit (130) comprises a machine learning algorithm. Said machine learning algorithm is trained with QCI based metrics, UE based metrics, UE information acquired in a TN network and NTN network. When UE information and network type (TN or NTN) is provided as input to machine learning algorithm, it generates predicted QCI based metrics for related network and UE based metrics for related user information. Machine learning algorithm may be trained with data related to trajectory of LEO satellites (222).

Subject matter handover management method of the present invention comprises following steps implemented by processor unit (120):
monitoring QCI based metrics for each service connected to a first network type or a second network type wherein first network type are different than each other and selected from a group consisting of terrestrial network and non-terrestrial network.
acquiring UE information and UE based metrics from user equipment (300) belonging to monitored services. For instance, user equipment (300) may currently use TN.
determining at least a candidate network for each service which is in different network type the network type currently being used by said services for handover. For instance, processor unit (120) may select NTN network as candidate network.
generating predicted UE based metric and predicted QCI based metric for a future time window using a machine learning algorithm for first network type and second network type using UE information as input, where said machine learning algorithm is trained with reference user equipment (300) information, reference UE based metric, reference QCI based metric taken on first network type and second network type. For instance, processor may generate predicted QCI based metrics and UE based metrics for t+10 minutes for NTN, t being the time metrics were acquired or measured.
if generated predicted UE metric and predicted QCI based metric meet predetermined conditions handover at least a service of user equipment (300) from existing network type to other network type. Said predetermined conditions may be predefined SLA (Service Level Agreement) conditions. For instance, SLA may comprise a QCI based metric being above predetermined threshold. Thus, processor unit (120) realizes handover if better QCI based metrics or UE based metrics will be acquired when switched to another network type.

In a possible embodiment, processor unit (120) determines maximum and minimum thresholds for QCI based metrics and UE based metrics. Processor unit (120) is configured to discard generated predictions if they exceed determined thresholds. Processor unit (120) may determine maximum and minimum thresholds based on historical measurements of metrics.

In a possible embodiment processor unit (120) may check if any QCI based metrics are violating related SLA. When a service is determined that its measured QCI metrics violate SLA, user equipment (300) related to determined service are detected. Detected user equipment (300) are prioritized for handover.

Data flow between handover management unit (100) and user equipment (300) may be realized through NR-Uu. Handover management units (100) provided on O-RAN transmission points (210) may share related metrics through the NG interface. O-RAN transmission points (210) may communicate through E2 or O1 interfaces.

The scope of protection of the invention is specified in the attached claims and cannot be limited to those explained for sampling purposes in this detailed description. It is evident that a person skilled in the art may exhibit similar embodiments in light of the above-mentioned facts without drifting apart from the main theme of the invention.

### REFERENCE NUMBERS GIVEN IN THE FIGURE

100 Handover management unit
   110 Communication interface
   120 Processor unit
   130 Memory unit
201 Network Controller
210 Transmission point
221 GEO Satellite
222 LEO Satellite
223 Aerial Unit
300 User Equipment

What is claimed is:

1. A handover management method realized by a handover management unit for controlling handover of user equipment between a terrestrial network and non-terrestrial network, comprising steps of:
monitoring quality of service class identifier (QCI) based metrics for each service connected to a first network type or a second network type wherein first network type are different than each other and selected from a group consisting of terrestrial network and non-terrestrial network,
acquiring user equipment (UE) information and UE based metrics from user equipment belonging to monitored services;
determining at least a candidate network for each service which is in different network type the network type currently being used by said services for handover;
generating predicted UE based metric and predicted QCI based metric for a future time window using a machine learning algorithm for first network type and second network type using UE information as input, where the machine learning algorithm is trained with reference user equipment information, reference UE based metric, reference QCI based metric taken on first network type and second network type;
when generated predicted UE metric and predicted QCI based metric meet predetermined conditions, handovering at least a service of user equipment from existing network type to other network type.

2. The handover management method according to claim 1, wherein the QCI based metrics are selected from a group consisting of: packet delay measurement; radio resource utilization measurement, radio resource control (RRC) connection number measurement and protocol data unit (PDU) session management metric.

3. The handover management_method according to claim 1, wherein the UE based metrics are selected from a group consisting of: evolved universal terrestrial radio access network (E-UTRAN)-radio access bearer (RAB) (E-RAB) Accessibility, E-RAB Retain ability, E-UTRAN internet protocol (IP) Throughput, E-UTRAN IP Latency, E-UTRAN Cell Availability, E-UTRAN Mobility, and Packet Delay.

4. The handover management method according to claim 1, wherein the UE information is selected from a group consisting of: UE type, UE location, UE speed, and UE movement direction.

5. A handover management unit comprising a communication interface for acquiring metrics from user equipment, terrestrial network and non-terrestrial network; a processor configured to receive acquired metrics and control handover of user equipment; and a memory unit for storing data, wherein the handover management unit is configured to perform following steps:
monitoring QCI based metrics for each service connected to a first network type or a second network type wherein first network type are different than each other and selected from a group consisting of terrestrial network and non-terrestrial network,
acquiring UE information and UE based metrics from user equipment belonging to monitored services;
determining at least a candidate network for each service which is in different network type the network type currently being used by said services for handover;
generating predicted UE based metric and predicted QCI based metric for a future time window using a machine learning algorithm for first network type and second network type using UE information as input, where the machine learning algorithm is trained with reference user equipment information, reference UE based metric, reference QCI based metric taken on first network type and second network type;
when generated predicted UE metric and predicted QCI based metric meet predetermined conditions, handovering at least a service of user equipment from existing network type to other network type.

6. The handover management unit according to claim 5, wherein the handover management unit is provided in transmission points in the terrestrial network.

7. The handover management unit according to claim 5, wherein the handover management unit is provided on low earth orbit (LEO) satellite or aerial units in the non-terrestrial network.
